(19) United States
(12) Patent Application Publication
(10) Pub. No.: US 2012/0174585 A1
(43) Pub. Date: Jul. 12, 2012

(54) CLOSED LOOP THERMODYNAMIC MACHINE

(75) Inventors: William Hugh Salvin Rampen, Edinburgh (GB); Ronan Patrick Costello, Waterfall (IE)

(73) Assignee: New Malone Company Limited, Edinburgh (GB)

(21) Appl. No.: 13/389,747

(22) PCT Filed: Aug. 11, 2010
(86) PCT No.: PCT/GB10/51333

§ 371 Date: Mar. 26, 2012

(30) Foreign Application Priority Data
Aug. 11, 2009 (GB) 0913988.2

(51) Int. Cl. F02C 1/04

(52) U.S. Cl. 60/682

(57) ABSTRACT

According to a first aspect of the invention there is provided a thermodynamic machine operating according to the Brayton cycle and including a closed loop fluid circuit for circulating working fluid. A fluid compressor (8) and a fluid expander (10) are independently controllable variable positive displacement machines. The variable positive displacement machines incorporate working chambers of cyclically varying volume, the net fluid displacement of each working chamber being selectable on a cycle by cycle basis. The compressor and expander axles are linked and the compressor and expander can be controlled to independently vary the displacement of the compressor, the displacement of the expander and the net torque exerted on the axle. The machine works efficiently with a wide range of heat source and heat sink temperatures and can respond to varying power demands, including transient changes to power demand.

### FIELD OF THE INVENTION

The invention relates to the field of closed loop thermodynamic machines, such as external combustion engines or refrigerators, that have a working fluid which circulates between a high pressure heat exchanger and a low pressure heat exchanger.

### BACKGROUND TO THE INVENTION

The invention will now be illustrated with reference to an example embodiment of a thermodynamic machine which operates substantially according to the Brayton cycle. A working fluid is compressed in an adiabatic process, heated in an isobaric process, expanded in an adiabatic process and cooled in an isobaric process. The thermodynamic machine typically functions as an engine, for example an external combustion engine. However, the machine may function as a refrigerator in which the steps of the above process are reversed.

The invention aims to provide a thermodynamic machine which is energy efficient and able to adapt dynamically to changes in demand and to changes in heat input and output temperature. Some embodiments of the invention aim to provide a thermodynamic machine which can efficiently and rapidly provide transient peaks of power output on demand.

### SUMMARY OF THE INVENTION

According to a first aspect of the invention there is provided a thermodynamic machine comprising a closed loop fluid circuit for retaining circulating working fluid, a fluid compressor and a fluid expander for acting on working fluid within the closed loop fluid circuit, the closed loop fluid circuit comprising a high pressure portion and a low pressure portion, the high pressure portion having a high pressure heat exchanger for receiving heat from or outputting heat to an external heat source or sink, the low pressure portion having a low pressure heat exchanger for outputting heat to or receiving heat from an external heat sink or source, characterised in that the fluid compressor and fluid expander are variable positive displacement machines.

The thermodynamic machine may be an engine, such as an external combustion engine, in which case the high pressure heat exchanger is arranged to exchange heat between an external heat source and working fluid within the high pressure portion of the fluid circuit and the low pressure heat exchanger is arranged to exchange heat between an external heat sink and working fluid within the low pressure portion of the fluid circuit. The thermodynamic machine may be a refrigerator, in which case the high pressure heat exchanger is arranged to exchange heat between working fluid within the high pressure portion of the fluid circuit and a heat sink and the low pressure heat exchanger is arranged to exchange heat between working fluid within the low pressure portion of the fluid circuit and an external heat source. The thermodynamic machine might be operable to function as an engine or as a refrigerator in alternative operating modes. The fluid compressor and the fluid expander act on working fluid within the closed loop fluid circuit in use. Thus, fluid compressor and the fluid expander are arranged to act on working fluid within the closed loop fluid circuit in use.

The terms “high pressure” and “low pressure” refer to relative pressures and are not intended to imply absolute values of the pressure within portions of the fluid circuit. Working fluid in the “high pressure portion” is higher than the pressure of working fluid in the “low pressure portion” in use. However, although the pressure of working fluid in the low pressure portion is lower than the pressure of working fluid in the high pressure portion, the pressure of working fluid within the low pressure portion is typically higher than ambient pressure. Preferably, the ratio of working fluid pressure within the high pressure portion to working fluid pressure within the low pressure portion is variable. Where the working fluid is a supercritical liquid, the pressure within the low pressure portion preferably remains above the critical point (e.g. at least 70 bar where the working fluid is supercritical carbon dioxide).

Preferably, the fluid compressor and fluid expander are independently variable positive displacement machines. By providing a positive displacement fluid compressor and a positive displacement fluid expander, each of which acts on working fluid in the fluid circuit, and which have independently variable displacements, the relative mass of working fluid in the high pressure portion and the low pressure portion of the fluid circuit, and related parameters such as the pressure within the high pressure portion and the low pressure portion can be controlled. Typically, the displacement of the fluid compressor and the displacement of the fluid expander can be varied in a common mode or a differential mode. Typically, the common mode varies the rate of circulation of working fluid around the fluid circuit and the differential mode varies the working fluid pressure ratio between the high and low pressure portions of the fluid circuit. The power output of the thermodynamic machine is typically a function of the product of the working fluid flow rate and the working fluid pressure ratio. Preferably, the controller can independently vary the displacement of the fluid compressor and the displacement of the fluid expander to simultaneously and independently vary the rate of circulation of working fluid and the working fluid pressure ratio.

Typically, the fluid compressor and fluid expander each have an axle. They may, for example, be radial or axial piston machines. Preferably, the axle of the fluid compressor and the axle of the fluid expander are linked, for example, mechanically, hydraulically or pneumatically linked. Preferably also, a power take off device is also linked to the axles of the fluid compressor and fluid expander. In a preferred embodiment, the fluid compressor axle and the fluid expander axle are different regions of a common axle. Preferably also, a power take off device is also mounted to or mechanically linked to the common axle. Thus, a common axle may extend between the power take off device, the compressor and the fluid expander. The power take off device may, for example, be a drive shaft, an electric generator, a fan belt or a hydraulic pump.

Preferably, the fluid displaced by the fluid compressor per rotation of the fluid compressor axle (which may be a region of the said common axle) is variable. Preferably also, the fluid displaced by the fluid expander per rotation of the fluid compressor axle (which may be a region of the said common axle) is variable. Thus, it is possible to control not only the amount of fluid displaced by the fluid compressor and fluid expander in a given period of time but also the amount of fluid displaced by the fluid compressor and fluid expander for a given rotation of the linked axles of the fluid compressor and the fluid expander. Thus, it is possible to control the torque transmitted to the power take off device axle independently of the net rate of working fluid circulation around the closed loop fluid circuit. Preferably, the net throughput of working fluid through the fluid compressor, the net throughput of working fluid through the fluid expander and the torque exerted on the power take off device are independently controllable.

Preferably, either or both the fluid compressor and the fluid expander are fluid working machines comprising at least one working chamber of cyclically varying volume and one or more electronically controllable valves operable to determine the net throughput of working fluid through the at least one working chamber on a cycle by cycle basis to enable the fluid displacement to be varied. Typically, volume cycles of the one or more working chambers of the fluid compressor are mechanically linked to rotation of the fluid compressor axle. Typically, volume cycles of the one or more working chambers of the fluid expander are mechanically linked to rotation of the fluid expander axle. Preferably, either or both the fluid compressor and the fluid expander comprise a plurality of working chambers, thereby increasing the amount of control available. The number of decision points at which control can be exercised per axle rotation will rise with the number of working chambers arranged around the axle.

Typically, the thermodynamic machine comprises at least one controller to control the displacement of the fluid compressor and the fluid expander. The at least one controller may control the one or more electrically controllable valves to select from a plurality of different net displacements. The fluid compressor and fluid expander may have separate controllers. A thermodynamic machine controller may be in electronic communication with the fluid compressor controller and fluid expander controller. A single thermodynamic machine controller may control the fluid compressor and the fluid expander. The plurality of different net displacements preferably include an idle cycle having no net displacement of working fluid. The plurality of different net displacement may include a maximum stroke cycle in which fluid having a displacement equal to the maximum stroke volume of the working chamber is displaced. Typically, the at least one controller is operable to receive and respond to a demand signal, for example, a torque demand signal.

Either or both said fluid working machines preferably comprise a low pressure manifold and a high pressure manifold and one or more valves, comprising at least one electronically valve, which regulate fluid communication between the working chamber of cyclically varying volume and the low and high pressure manifolds. Typically, an electronically controllable low pressure valve is provided in respect of the or each working chamber which regulates fluid flow between the respective low pressure manifold and the working chamber.

It may be that the fluid working machines are constructed so that the frictional torque on their respective axle is minimal during an idle cycle. This may be achieved, for example, by making the pressure within the crank case of each fluid working machine equal to the low pressure manifold pressure, by providing a bounce space or by using double acting pistons.

Preferably, the thermodynamic machine comprises one or more of: a temperature sensor for measuring the temperature of working fluid at a first location (typically the coldest location) within the high pressure region of the closed loop fluid circuit, a second temperature sensor for measuring the temperature of working fluid at a second location (typically the hottest location) within the high pressure region of the closed loop fluid circuit a temperature sensor for measuring the temperature of working fluid at a first location (typically the coldest location) within the low pressure region of the closed loop fluid circuit, a temperature sensor for measuring the temperature of working fluid at a second location (typically the hottest location) within the low pressure region of the closed loop fluid circuit, a pressure sensor for measuring the pressure of working fluid at a location within the high pressure region of the closed loop fluid circuit, a pressure sensor for measuring the pressure of working fluid at a location within the low pressure region of the closed loop fluid circuit. We have found that it is surprisingly important to measure the temperature of working fluid within the low pressure region of the closed loop fluid circuit.

Preferably, the thermodynamic machine comprises a temperature sensor for measuring the temperature of a heat source. Preferably, the thermodynamic machine comprises a temperature sensor for measuring the temperature of a heat sink. A temperature sensor may be provided to measure the temperature of the heat source indirectly. An estimated heat source temperature may be calculated and used by the one or more controllers.

Where the thermodynamic machine is an engine, or may operate as an engine in at least one operating mode, the machine may comprise an automatically controllable heat source in thermal communication with the high pressure heat exchanger, for example, a variable output burner. The thermodynamic machine controller may be operable to control the automatically controllable heat source, for example, responsive to a demand signal. In order to control the automatically controllable heat source, the thermodynamic machine controller may be operable to control the rate of supply of fuel to a variable output burner (and if required, the air/fuel ratio). Thus, the thermodynamic machine can respond appropriately to demand, and also to anticipated or transient demand. The thermodynamic machine may require to control the rate of supply of air to the variable output burner in common with controlling the rate of supply of fuel.

In response to increase in demand the controller may cause the displacement of the fluid expander to be increased (e.g. immediately) and, after a period of time, the displacement of the fluid compressor to be increased. The rate of supply of fuel to a variable output burner may also be increased (e.g. immediately in response to an increase in demand). In response to a decrease in demand the controller may cause the displacement of the fluid expander to be decreased (e.g. immediately) and, after a period of time, the displacement of the fluid compressor to be decreased. The rate of supply of fuel to a variable output burner may also be decreased (e.g. immediately in response to a decrease in demand).

The controller may be operable to control the fluid compressor and fluid expander to determine one or more operating parameters selected from a group comprising: the rate of working fluid flow into the high pressure portion, the rate of working fluid flow into the low pressure portion, the pressure at a location within the high pressure portion and the pressure at a location within the low pressure portion.

The controller is preferably operable to control the fluid compressor and fluid expander to determine one or more of the said operating parameters taking into account measurements made by one or more said sensors. The controller is preferably operable to control the fluid compressor and fluid expander to determine one or more of the said operating parameters taking into account a demand signal, for example a signal related to a desired current power output or torque. The controller may be operable to control the fluid compressor and fluid expander to determine one or more of the said operating parameters taking into account anticipated future power output requirements.

By a closed loop fluid circuit we refer to a circuit in which working fluid circulates, in contrast with open loop devices. Although it may be that no working fluid is introduced to or removed from the closed loop fluid circuit during normal use, it may be that a small amount of working fluid can be introduced into or removed from the closed loop fluid circuit in use through one or more inlets or outlets. The transfer of working fluid through the said inlets or outlets may be controlled by valves or by a further fluid working machine. The fluid transferred through the said inlets or outlets may be transferred to one or more fluid reservoirs, for example pressurised storage vessels or hydraulic accumulators. Such reservoirs may be permanently attached to the thermodynamic machine, or demountably connectable to facilitate temporary removal (e.g. for the purpose of maintenance). Control of said valves or further fluid working machines may be automatic (for example under the automatic control of the one or more controllers) or manual. Said further fluid working machine may be disengagably powered by the axle of the fluid expander or may be independently powered, for example electrically powered.

A regenerator heat exchanger may be provided, in thermal communication with a region of the high pressure portion of the fluid circuit and a region of the low pressure portion of the fluid circuit.

One or more pulsation damping devices may be provided within the fluid circuit to attenuate pulses of fluid pressure. These pulses may arise from the introduction of working fluid into the high pressure portion and the low pressure portion as discrete pulses from the venting of working chambers of the fluid compressor and the fluid expander. The pulsation damping devices may, for example, be chambers where the working fluid has, at the temperature and pressure within the chamber in use, sufficient compressibility to attenuate pressure pulses, or a hydraulic accumulator. One or more pulsation damping devices may, for example, be provided at the interfaces between the (high and low pressure) heat exchangers and the fluid compressor and fluid expander.

A plurality of fluid compressors may be provided for acting on working fluid in the fluid circuit. Further heat exchangers, functioning as intercoolers, may be provided intermediate the said plurality of fluid compressors. A plurality of fluid expanders may be provided. Further heat exchangers, functioning as re-heaters, may be provided intermediate the said plurality of fluid expanders. A plurality of the said fluid compressors and/or a plurality of the said fluid expanders may be independently variable positive displacement fluid working machines. Some of all of the plurality of said fluid compressor and/or some or all of the plurality of said fluid expanders may have linked axles. A common axle may extend between a power take off device and a plurality of fluid compressors and a plurality of fluid expanders.

The one or more said fluid compressors displace working fluid from the low pressure portion of the fluid circuit into the high pressure portion of the fluid circuit. The one or more said fluid expanders displace working fluid from the high pressure portion of the fluid circuit into the low pressure portion of the fluid circuit.

The high pressure portion of the fluid expander typically extends from the output of a or the said fluid compressor to the input of a or the said fluid expanders. The fluid circuit may be divided into the high pressure portion and the low pressure portion by the or each fluid compressor and the or each fluid expander.

The thermodynamic machine may further comprise one or more fluid circuit branches which extend from and rejoin the fluid circuit. Fluid within a said fluid circuit branch may be subjected to a further thermodynamic process, for example a compression process (e.g. an adiabatic compression process). A further positive displacement fluid working machine, which is preferably also of variable displacement, may act on fluid within a said fluid circuit branch. A fluid circuit branch may extend from and rejoin the low pressure portion of the fluid circuit downstream of the outlet from the low pressure portion side of a regenerator heat exchanger and rejoin the low pressure portion of the fluid circuit upstream of the low pressure heat exchanger. A fluid circuit branch may extend from and rejoin the high pressure portion of the fluid circuit within the high pressure side of a regenerator heat exchanger.

The volume for receiving working fluid within the low pressure portion of the fluid circuit may be significantly greater than the volume for receiving working fluid within the high pressure portion of the fluid circuit.

The working fluid may be a liquid. The working fluid may be a gas. The working fluid may be a supercritical fluid, for example supercritical carbon dioxide. The supercritical fluid may be maintained above its critical point throughout its working cycle.

According to a second aspect of the invention there is provided a method of operating a thermodynamic machine according to the first aspect of the present invention comprising varying the displacement of either or both the compressor and the expander responsive to one or more inputs.

The inputs may comprise a demand signal, for example, an output power demand or an output torque demand signal. The input may comprise a signal representative of anticipated future demand.

The inputs may comprise one or more of: a temperature signal concerning the temperature of working fluid at a location within the low pressure portion; a temperature signal concerning the temperature of working fluid at a location within the high pressure portion; a temperature signal concerning the temperature at a heat source or heat sink in thermal communication with the high pressure heat sink; a temperature signal concerning the temperature at a heat source or heat sink in thermal communication with the low pressure heat sink; the working fluid pressure at a location within the high pressure portion; the working fluid pressure at a location with the low pressure portion; a signal related to the power output of the machine; and the angular position, angular velocity or angular acceleration of one or more of the compressor axle, the expander axle, a common axle, an axle within a power take off device.

The method may further comprise the step of controlling the heat output of a heat source in thermal communication with the high pressure heat exchanger. For example, where the high heat source is a burner which combusts fuel, the method may comprise controlling the rate of supply of fuel to the burner.

The method may comprise the step of varying the displacement of working fluid by the compressor and the expander independently. It may be that the displacement of working fluid by either or both the compressor and the expander is variable by varying the speed of rotation of a compressor axle or an expander axle respectively. It may be that the displacement of working fluid by either or both the compressor and the expander per rotation of a compressor axle or an expander axle respectively may be varied. The method may comprise the step of varying the net throughput of working fluid by either or both the compressor and the expander independently of the torque applied to an axle of a power take off device.

The volume of working fluid within the low pressure portion of the fluid circuit may be significantly greater than the volume of working fluid within the high pressure portion of the fluid circuit in use.

The invention extends in a third aspect to computer software comprising program instructions which, when executed on a thermodynamic machine controller, cause the thermodynamic machine to function as a thermodynamic machine according to the first aspect of the invention or according to the method of the second aspect of the invention. The invention extends to a computer readable storage medium storing computer software according to the third aspect of the invention.

### DESCRIPTION OF THE DRAWINGS

An example embodiment of the present invention will now be illustrated with reference to the following Figures in which:

FIG. 1 is a schematic diagram of an engine according to the invention;

FIG. 2 is a schematic diagram of inputs to and outputs from a thermodynamic machine controller;

FIG. 3 is a schematic diagram of a fluid working machine for use in the engine of FIG. 1; and

FIG. 4 illustrates the variation in pressure with time during a cycle of volume of the working chamber of the fluid working machine of FIG. 3, when utilized as the fluid expander.

### DETAILED DESCRIPTION OF AN EXAMPLE EMBODIMENT

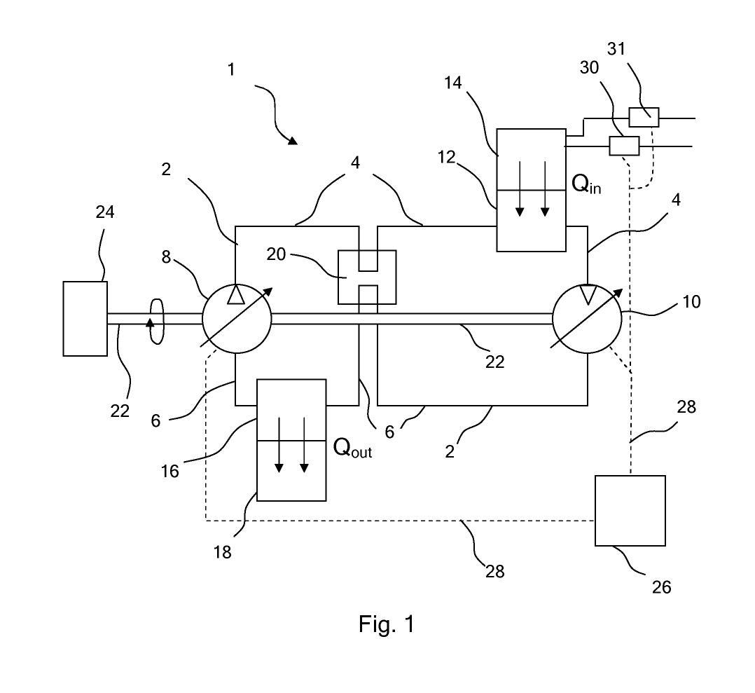

With reference to FIG. 1, an external combustion engine shown generally as 1 (functioning as a thermodynamic machine) comprises a closed loop fluid circuit 2, having a high pressure side 4 (functioning as the high pressure portion), and a low pressure side 6 (functioning as the low pressure portion). The closed loop fluid circuit retains supercritical carbon dioxide as working fluid, and the working fluid is directed around the fluid circuit by a compressor 8 (functioning as the variable positive displacement fluid compressor) and an expander 10 (functioning as the variable positive displacement fluid expander).

The high pressure side includes a first heat exchanger 12 (the high pressure side heat exchanger), in thermal communication with a heat source 14, for heating working fluid within the high pressure side. Similarly, the low pressure side includes a second heat exchanger 16 (the low pressure side heat exchanger), in thermal communication with a heat sink 18. A further heat exchanger 20 is provided for transferring heat from the low pressure side, upstream of the second heat exchanger, to the low pressure side, upstream of the first heat exchanger.

The compressor and the expander share a common axle 22 (including both the fluid compressor axle and the fluid expander axle). An electricity generator 24 is also mounted to the common axle, and functions as the power take off device. Instead of an electricity generator, the power takeoff device might, for example, be a hydraulic pump, or a vehicle drive train.

A controller 26, such as a microprocessor or microcontroller, is in electronic communication with the compressor, and the expander, by way of electrical wires 28. In this example embodiment, the heat source is a controllable burner, and the controller is also in electronic communication with a fuel pump 30 to vary the supply of fuel to the burner, and thereby vary the heat output of the burner. An air blower 31 is typically also provided and controlled along with the fuel pump to maintain a suitable air-fuel ratio.

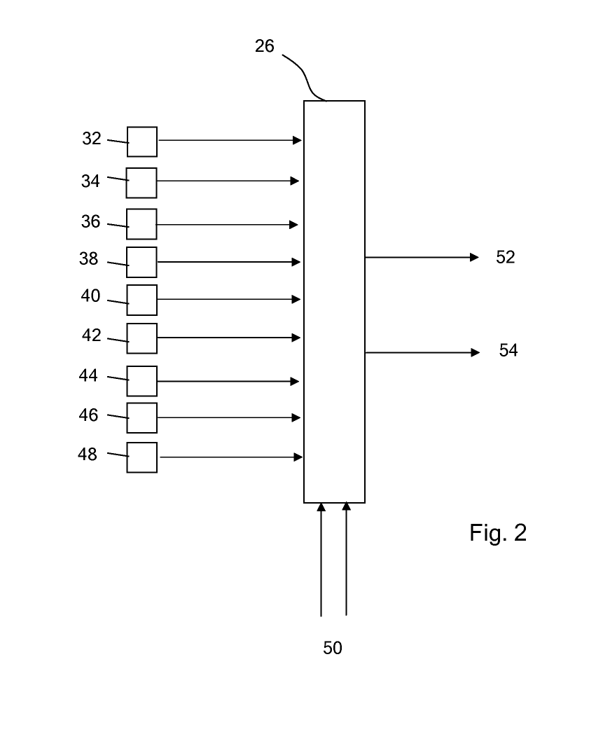

With reference to FIG. 2, the controller receives continuous inputs from a temperature sensor 32, arranged to measure the temperature of working fluid entering the low pressure side heat exchanger, a temperature sensor 34, arranged to measure the temperature of working fluid entering the high pressure side heat exchanger, first and second high pressure side pressure sensors 36, 38, arranged to measure the pressure of working fluid upstream and downstream of the high pressure side heat exchanger, first and second the low pressure side pressure sensors 40, 42, arranged to measure the pressure of working fluid upstream and downstream of the low pressure side heat exchanger, a heat source temperature sensor 42, arranged to measure the current temperature within the heat source, a heat rejector temperature sensor 44, arranged to measure the current temperature within the heat sink, a shaft position sensor 46, operable to determine the current angle of the shaft, and a torque sensor 48, operable to determine the instantaneous torque exerted on and by the shaft. The torque sensor might function by measuring the instantaneous current output of the electricity generator. The controller also receives a demand signal 50, indicative of the desired power output of the engine.

In order to control the machine, the controller sends control signals 52 to the compressor and the expander to determine the net throughput of working fluid through each of the compressor and the expander. In some embodiments, these control signals might be demand signals which specify a demand fluid displacement per unit time or shaft rotation, and the compressor and the expander may have their own controllers which receives these control signals and interpret them to provide the demanded throughput of working fluid. In other embodiments, the controller sends signals directly to the compressor and the expander to control the variation of working fluid throughput. For example, when using fluid working machines in which the displacement of fluid by individual working chambers is selected on a cycle by cycle basis by the active control of electronically controllable valves, as described below, the controller may send valve control signals directly to the compressor and the expander.

The controller can also send a fuel pump control signal 54 to the fuel pump, and an air blower control signal to the air blower, to regulate the power output and/or temperature of the heat source.

The compressor and the expander can each be fluid working machines which comprise a plurality of working chambers of cyclically varying volume, in which the displacement of fluid through the working chambers is regulated by electronically controllable valves, on a cycle by cycle basis and in phased relationship to cycles of working chamber volume, to determine the net throughput of fluid through the machine. Suitable fluid working machines include Digital Displacement brand pumps and motors manufactured under licence from Artemis Intelligent Power Limited. (Digital Displacement is a trade mark of Artemis Intelligent Power Limited).

Fluid working machines of this type are disclosed, for example, in EP 0 361 927 which introduced a method of controlling the net throughput of fluid through a multi-chamber pump by opening and/or closing electronically controllable poppet valves, in phased relationship to cycles of working chamber volume, to regulate fluid communication between individual working chambers of the pump and a low pressure manifold. As a result, individual chambers are selectable by a controller, on a cycle by cycle basis, to either displace a predetermined volume of fluid or to undergo an idle cycle with no net displacement of fluid, thereby enabling the net throughput of the pump to be matched dynamically to demand. EP 0 494 236 developed this principle and included electronically controllable poppet valves which regulate fluid communication between individual working chambers and a high pressure manifold, thereby facilitating the provision of a fluid working machine functioning as either a pump or a motor in alternative operating modes. EP 1 537 333 introduced the possibility of part cycles, allowing individual cycles of individual working chambers to displace any of a plurality of different volumes of fluid to better match demand.

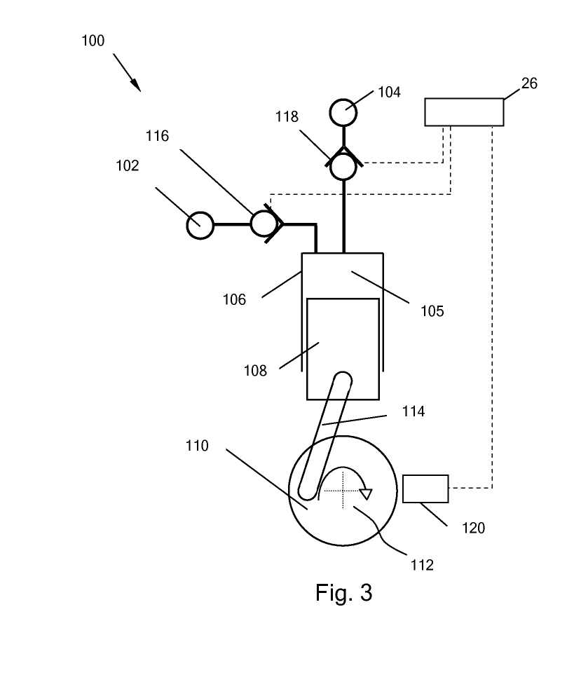

With reference to FIG. 3, a variable positive displacement machine 100, usable as the compressor, has a low pressure manifold 102 connected to the low pressure side of the fluid circuit, and a high pressure manifold 104 connected to the high pressure side of the fluid circuit. A working chamber is defined by the interior of a cylinder 106 and a piston 108 which is mechanically linked to the rotation of a cam 110 mounted on an axle 112 by a suitable mechanical linkage 114, and which reciprocates within the cylinder to cyclically vary the volume of the working chamber. A low pressure valve 116 regulates the flow of hydraulic fluid between the low pressure manifold and the working chamber. A check valve 118 functions as a high pressure valve, regulating the flow of fluid from the working chamber to the high pressure side of the fluid circuit. The example fluid working machine includes a plurality of working chambers mechanically linked to the rotation of the same axle, with appropriate phase differences. A shaft position and speed sensor 118 determines the instantaneous angular position and speed of rotation of the shaft, and transmits shaft position and speed signals to the controller which enables a controller to determine instantaneous phase of the cycles of each individual working chamber. The controller is typically a microprocessor or microcontroller which executes a stored program in use. The low pressure valve is electronically actuatable, and the opening and/or the closing of at least the low pressure valves is under the active control of the controller.

The controller regulates the opening and/or closing of the low pressure valves to determine the displacement of fluid through each working chamber, on a cycle by cycle basis, in phased relationship to cycles of a working chamber volume, to determine the net throughput of fluid through the machine. During each expansion stroke, the low pressure valve is open and working fluid is received from the low pressure side of the fluid circuit. The controller may determine for each cycle of each working chamber whether the working chamber should then complete a full pumping cycle, closing the low pressure valve and displacing the maximum possible volume of working fluid through the high pressure valve to the high pressure side of the fluid circuit, or an idle cycle in which the low pressure valve remains open and working fluid returns to the low pressure side. In some embodiments, the controller may control the precise time during a contraction stroke at which the low pressure valve closes, and thereby select the amount of fluid displaced to the high pressure side from amongst a range of possible displacements. Thus, the compressor functions as a fluid working pump according to the principles disclosed in EP 0 361 927 and EP 1 537 333, the contents of which are incorporated herein by virtue of this reference. The expander may correspond in structure to the compressor except that the high pressure valve should also be actively controlled. Where the machine is to be used as an external combustion the expander will typically require to operate at a higher temperature than the compressor and can be adapted accordingly. The expander carries out motoring strokes according to the principles described in EP 0 494 236. During a contraction stroke, fluid is vented from the working chamber to the low pressure side through the low pressure valve. The controller determines on a cycle by cycle basis whether to maintain the low pressure valve open (either by actively holding the low pressure valve open or by selectively not actively holding the low pressure valve closed depending upon the biasing of the low pressure valve and the forces on the valve arising from fluid flow) in which case an idle stroke occurs, or closing the low pressure valve before top dead centre, causing pressure to build up in the working chamber as the cylinder volume shrinks, enabling the high pressure valve to open under the active control of the controller (which either actively open the high pressure valve or selectively does not actively hold the high pressure valve closed depending upon the biasing of the high pressure valve and the forces acting on the valve arising from fluid flow). If the high pressure valve opens, working fluid is received from the high pressure side of the fluid circuit. The high pressure valve is actively closed or allowed to close before bottom dead centre whereupon pressure with the working chamber drops, enabling the low pressure valve to open or be actively opened for the following contraction stroke. In a part stroke mode, the controller actively closes the high pressure valve, or allows it to close, during the expansion stroke, before the maximum possible volume of working fluid has been received from the high pressure side. Accordingly, the expander may be a motor according to EP 0 494 236 or EP 1 537 333.

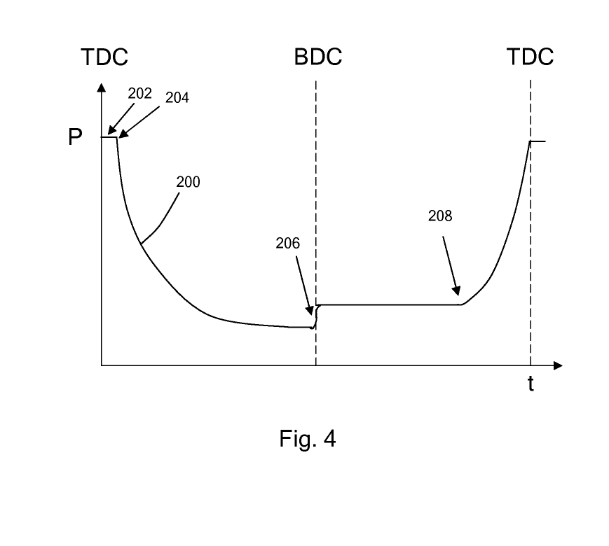

FIG. 4 illustrates the variation in pressure 200 within the working chamber of the expander in use, during a stroke in which the controller determines that working fluid should be displaced. At top dead centre the low pressure valve and high pressure valve are closed. The high pressure valve is opened 202 shortly after top dead centre to enable working fluid to flow into the working chamber from the high pressure side. Shortly thereafter the working chamber has received the maximum volume of working fluid which it can receive given that it must vent the fluid at a significantly lower pressure. The high pressure valve is closed 204. The working chamber is now a closed volume and so the pressure within the working chamber drops until it is close to, at or below the pressure within the low pressure side, before bottom dead centre. The low pressure valve is then opened 206 and working fluid is vented to the low pressure side of the fluid circuit. Later in the contraction stroke, the low pressure valve is closed 208 and the pressure of the working fluid remaining in the working chamber increases as the working chamber volume is reduced, to enable the high pressure valve to be opened again. The controller may, during some cycles, select an idle cycle in which there is no net displacement of fluid by keeping the low pressure valve open throughout the contraction stroke in which case the high pressure valve cannot be opened. In alternative embodiments, the low pressure valve may be opened against a pressure differential, before pressure within the working chamber has reduced to the pressure of the low pressure manifold. Similarly, the high pressure valve may be opened against a pressure differential, before pressure within the working chamber has increased to the pressure of the high pressure manifold.

The most appropriate machines to use as compressor and expander will depend on the intended application. For machines which circulate working fluid only in a single direction, the compressor may be operable only to function as a pump and the expander may be operable only to function as a motor. The actively controlled high pressure valve of the pump may, for example, be replaced with a check valve. When the machine is to be used as an external combustion engine, the expander will typically be adapted to operate at a higher temperature than the compressor.

In use, the controller continuously monitors the sensors described above with reference to FIG. 2 and a demand signal. The controller calculates a target rate of working fluid circulation and target working fluid pressure at one or more locations within the high and low pressure sides of the fluid circuit, taking into account applicable constraints, such as the temperature of the heat source and heat exchange, and the mass of working fluid present in the fluid circuit. The controller may use mathematical models of the thermodynamic machine to calculate the target rate of working fluid circulation and target working fluid pressure, or a look-up table of previously stored values. The controller then actively controls displacement of the compressor and expander. In particular, on each occasion where the controller can select the displacement of a working chamber in the compressor or the expander, the controller makes a decision as to the displacement of working fluid which should occur during that cycle of working chamber volume taking into the calculations which have been made. In determining electronic valve timing signals the controller can take into account the measured pressure in the high and low pressure sides which determines the ratio of the volume of working fluid which is received from the high or low pressure side, as appropriate, to the volume of working fluid which is vented to the low or high pressure side, respectively.

Typically, the controller will have a mode in which the time averaged displacement of working fluid through both the compressor and the expander are changed in common, to vary the rate of circulation of working fluid without immediately changing the pressure in the high and low pressure sides. (In practice, the pressure in the high and low pressure sides will change over time as a result of the change in rate of circulation of working fluid). Typically, the controller will also have a mode in which the time averaged displacement of working fluid through the compressor and the expander are varied independently, to cause a net movement of working fluid from the low pressure side to the high pressure side or vice versa, for a period of time.

The actions of the controller not only affect the relative time averaged displacement of the compressor and the expander, but also affect the torque applied to the common axle. The compressor converts shaft power into fluid power by pressurizing and displacing the working fluid and the expander converts fluid power into shaft power by the action of expanding working fluid on the working chamber piston. Thus, the controller can change the rate of circulation of working fluid, and the relative displacement of the compressor and the expander, independently of the torque applied to the common axle. This provides a useful additional degree of freedom, enabling the torque to be selected for efficient power generation. In an application such as a vehicle where the power take off device is a drive shaft the ability to vary torque can be very helpful. Furthermore, as the controller can make frequent decisions as to the displacement of fluid by individual working chambers, the torque can be varied very quickly, and potentially within milliseconds of a demand signal indicating that the torque should be changed. This enables the engine to respond well to transient torque demands. In response to a transient increase in torque demand the engine may, for example, immediately increase fuel flow to the heat source and the displacement per axle revolution of the expander. After a period of time the displacement per axle revolution of the compressor would increase. In response to a transient decrease in torque demand the engine may, for example, immediately decrease fuel flow to the heat source and the displacement per axle revolution of the expander. After a period of time the displacement per axle revolution of the compressor would also decrease.

The absolute value of working fluid pressure in the high and low pressure sides will typically vary in use. The working fluid pressure will typically be different on either side of each heat sink within the fluid circuit but this difference is usually relatively small compared to the different in working fluid pressure between the high pressure and low pressure sides of the fluid circuit. In an engine in which the heat source is around 800° C., the working fluid pressure might average 50 to 100 bar within the low pressure side and 250 to 500 bar within the high pressure side in typical operating conditions. The ratio of working fluid pressure in the high pressure side to working fluid pressure in the low pressure side may typically range between 2 and 10.

Although the power output of the heat source is controllable by the controller in the example embodiment, in some embodiments, the power output of the heat source will not be within the control of the controller. Indeed, a benefit of the invention is that the various operating parameters can be adjusted on a continuous basis for optimum operation given varying power demand, varying heat input, and varying heat rejection. Thus, the invention is useful for the generation of power from the combustion of varying and mixed feedstocks, for example domestic, industrial and agricultural waste

Furthermore, although the example embodiment is an external combustion engine, the compressor and expander can be reversed, and the machine will function as a refrigerator. In some embodiments, the machine may function as either as an engine or as a refrigerator in alternate operating modes. In this case, the compressor and expander may be fluid working machines operable to function as a compressor or an expander in alternate operating modes, for example, fluid working pump-motors according to the principles disclosed in EP 0 494 236 and EP 1 537 333.

Multiple compressors may be employed in which case they will typically have intercoolers therebetween. Multiple expander may be employed in which case they will typically have re-heaters therebetween. The fluid circuit may be in communication with fluid circuit branches. Working fluid can be directed into the fluid circuit branches, subjected to one or more additional thermodynamic processes, such as compression, and then reintroduced to the fluid circuit.

Further variations and modifications may be made within the scope of the invention herein disclosed.

1. A thermodynamic machine comprising a closed loop fluid circuit for retaining circulating working fluid, a fluid compressor and a fluid expander for acting on working fluid within the closed loop fluid circuit, the closed loop fluid circuit comprising a high pressure portion and a low pressure portion, the high pressure portion having a high pressure heat exchanger for receiving heat from or outputting heat to an external heat source or sink, the low pressure portion having a low pressure, heat exchanger for outputting heat to or receiving heat from an external heat sink or source, characterised in that the fluid compressor and fluid expander are independently variable positive displacement machines.

2. A thermodynamic machine according to claim 1, wherein the displacement of the fluid compressor and the displacement of the fluid expander can be varied in a common mode or a differential mode.

3. A thermodynamic machine according to claim 1, wherein the fluid compressor and fluid expander each have an axle and the axle of the fluid compressor and the axle of the fluid expander are linked.

4. A thermodynamic machine according to claim 3, comprising a common axle including the fluid compressor axle and the fluid expander axle.

5. A thermodynamic machine according to claim 3, further comprising a power take off device linked to the axles of the fluid compressor and fluid expander.

6. A thermodynamic machine according to claim 5, wherein the net throughput of working fluid through the fluid compressor, the net throughput of working fluid through the fluid expander and the torque exerted on the power take off device are independently controllable.

7. A thermodynamic machine according to claim 1, wherein either or both the fluid compressor and the fluid expander are fluid working machines comprising at least one working chamber of cyclically varying volume and one or more electronically controllable valves operable to determine the net throughput of working fluid through the at least one working chamber on a cycle by cycle basis to enable the fluid displacement to be varied.

8. A thermodynamic machine according to claim 7, further comprising a controller operable to control the one or more electrically controllable valves to select from a plurality of different net displacements.

9. A thermodynamic machine according to claim 7, wherein the controller is operable to receive and respond to a demand signal.

10. A thermodynamic machine according to claim 1, comprising one or more of: a temperature sensor for measuring the temperature of working fluid at a first location within the high pressure region of the closed loop fluid circuit, a second temperature sensor for measuring the temperature of working fluid at a second location within the high pressure region of the closed loop fluid circuit a temperature sensor for measuring the temperature of working fluid at a first location within the low pressure region of the closed loop fluid circuit, a temperature sensor for measuring the temperature of working fluid at a second location within the low pressure region of the closed loop fluid circuit, a pressure sensor for measuring the pressure of working fluid at a location within the high pressure region of the closed loop fluid circuit, a pressure sensor for measuring the pressure of working fluid at a location within the low pressure region of the closed loop fluid circuit.

11. A thermodynamic machine according to claim 1, wherein the thermodynamic machine is an external combustion engine, the high pressure heat exchanger is arranged to exchange heat between an external heat source and working fluid within the high pressure portion of the fluid circuit and the low pressure heat exchanger is arranged to exchange heat between an external heat sink and working fluid within the low pressure portion of the fluid circuit.

12. A thermodynamic machine according to claim 1, wherein the thermodynamic machine is an engine, or may operate as an engine in at least one operating mode, and the machine comprises an automatically controllable heat source in thermal communication with the high pressure heat exchanger.

13. A thermodynamic machine according to claim 1, wherein the thermodynamic machine comprises a controller operable to control the fluid compressor and fluid expander to determine one or more operating parameters selected from a group comprising: the rate of working fluid flow into the high pressure portion, the rate of working fluid flow into the low pressure portion, the pressure at a location within the high pressure portion and the pressure at a location within the low pressure portion.

14. A thermodynamic machine according to claim 1, further comprising a regenerator heat exchanger in thermal communication with a region of the high pressure portion of the fluid circuit and a region of the low pressure portion of the fluid circuit.

15. A thermodynamic machine according to claim 1, comprising one or more fluid circuit branches which extend from and rejoin the closed loop fluid circuit.

16. A thermodynamic machine according to claim 15, wherein fluid within a said fluid circuit branch is subjected to a further thermodynamic process.

17. A thermodynamic machine according to claim 16, wherein an independently variable positive displacement fluid working machine is provided which subjects fluid within the fluid circuit branch to a further thermodynamic process.

18. A thermodynamic machine according to claim 1, comprising a plurality of fluid compressors with intercoolers therebetween and/or a plurality of fluid expanders with re-heaters therebetween.

19. A thermodynamic machine according to claim 1, comprising supercritical carbon dioxide as working fluid.

20. A method of operating a thermodynamic machine according to claim 1 comprising varying the displacement of either or both the compressor and the expander responsive to one or more inputs.

21. A method according to claim 20, wherein the inputs comprise a demand signal.

22. A method according to claim 20, wherein the inputs comprise one or more of: a temperature signal concerning the temperature of working fluid at a location within the low pressure portion; a temperature signal concerning the temperature of working fluid at a location within the high pressure portion; a temperature signal concerning the temperature at a heat source or heat sink in thermal communication with the high pressure heat sink; a temperature signal concerning the temperature at a heat source or heat sink in thermal communication with the low pressure heat sink; the working fluid pressure at a location within the high pressure portion; the working fluid pressure at a location with the low pressure portion; a signal related to the power output of the machine; and the angular position, angular velocity or angular acceleration of one or more of the compressor axle, the expander axle, a common axle, an axle within a power take off device.

23. A method according to claim 20, wherein the thermodynamic machine is an external combustion engine and the method further comprises the step of controlling the heat output of a heat source in thermal communication with the high pressure heat exchanger.

24. A method according to claim 20, comprising the step of varying the displacement of working fluid by the compressor and the expander independently.

25. A method according to claim 20, wherein the machine comprises a power take off device and the power take off device, the compressor and the expander have linked axles, wherein the method comprises varying the net throughput of working fluid by either or both the compressor and the expander independently of the torque applied to the axle of the power take off device.

26. Computer software comprising program instructions which, when executed on a thermodynamic machine controller, cause the thermodynamic machine to function as a thermodynamic machine according to claim 1.
